(19) United States
(12) Patent Application Publication
(10) Pub. No.: US 2025/0158449 A1
(43) Pub. Date: May 15, 2025

(54) CHARGING REQUESTS FOR BACKSCATTERING AND POWER HARVESTING DEVICES

(71) Applicant: Cisco Technology, Inc., San Jose, CA (US)

(72) Inventors: Ugo M. CAMPIGLIO, Morges (CH); Domenico FICARA, Essertines-Sur-Yverdon (CH); Amine CHOUKIR, Ecublens (CH); Jerome HENRY, Pittsboro, NC (US); Indermeet S. GANDHI, San Jose, CA (US); Leo CALDAROLA, Morrens (CH)

(21) Appl. No.: 18/509,142

(22) Filed: Nov. 14, 2023

(51) Int. Cl. H02J 50/00; H04W 52/34

(52) U.S. Cl. CPC H02J 50/001; H04W 52/34

(57) ABSTRACT

The present disclosure describes systems and methods for negotiating power harvesting. An access point includes a memory and a processor communicatively coupled to the memory. The processor receives, from a first device, a first message indicating a first amount of power harvested by the first device and a second amount of power requested by the first device and determines, based on the first amount of power, that transmitting a third amount of power will cause the first device to receive the second amount of power. The processor also transmits the third amount of power.

### TECHNICAL FIELD

Embodiments presented in this disclosure generally relate to wireless communication. More specifically, embodiments disclosed herein relate to charging requests for backscattering and power harvesting devices.

### BACKGROUND

Access points may be used to provide wireless access to devices in wireless networks. Some devices may harvest electrical energy or power from the wireless signals transmitted by the access points. The devices may use the harvested electrical energy or power to perform some of the functions of the devices.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example access point in the system of FIG. 1A.

FIG. 2 illustrates an example operation performed by the system of FIG. 1A.

FIG. 3 illustrates an example operation performed by the system of FIG. 1A.

FIG. 4 illustrates an example operation performed by the system of FIG. 1A.

FIG. 5 is a flowchart of an example method performed by the system of FIG. 1A.

FIG. 6 is a flowchart of an example method performed by the system of FIG. 1A.

FIG. 7 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes systems and methods for negotiating power harvesting. According to an embodiment, an access point includes a memory and a processor communicatively coupled to the memory. The processor receives, from a first device, a first message indicating a first amount of power harvested by the first device and a second amount of power requested by the first device and determines, based on the first amount of power, that transmitting a third amount of power will cause the first device to receive the second amount of power. The processor also transmits the third amount of power.

According to another embodiment, a method includes receiving, at an access point and from a first device, a first message indicating a first amount of power harvested by the first device and a second amount of power requested by the first device and determining, by the access point and based on the first amount of power, that transmitting a third amount of power will cause the first device to receive the second amount of power. The method also includes transmitting, by the access point, the third amount of power.

According to another embodiment, an apparatus includes a memory and a processor communicatively coupled to the memory. The processor receives, from a first device, a first message indicating a first amount of power harvested by the first device and a second amount of power requested by the first device and transmits, based on the first amount of power, a third amount of power such that the first device receives the second amount of power.

### EXAMPLE EMBODIMENTS

Access points may be used to provide wireless access to devices in wireless networks. Some devices may harvest electrical energy or power from the wireless signals transmitted by the access points, and the devices may use the harvested electrical energy or power to perform some of the functions of the devices. An access point, however, may not know how much power to transmit for harvesting to provide sufficient power to the devices. As a result, the access point may transmit too little power, which results in the devices not functioning properly. Alternatively, the access point may transmit too much power, which wastes computing resources and electrical power.

The present disclosure describes an access point that allows devices to associate with the access point and to negotiate power transmissions with the access point. For example, if a device needs the access point to transmit power to the device for harvesting, the device may communicate a message to the access point to inform the access point of the power previously harvested by the device and the power needed by the device. The access point may analyze these messages from multiple devices to determine or calculate a total power to be transmitted that will provide the power needed by each of the devices. The access point may then transmit this total power. The access point may adjust the amount of power in subsequent transmissions based on devices informing the access point of the amount of power the devices harvested from the transmission. In this manner, the access point determines and transmits an amount of power that provides for the power needs of the devices. As a result, the access point conserves computing resources and conserves electrical power, in certain embodiments.

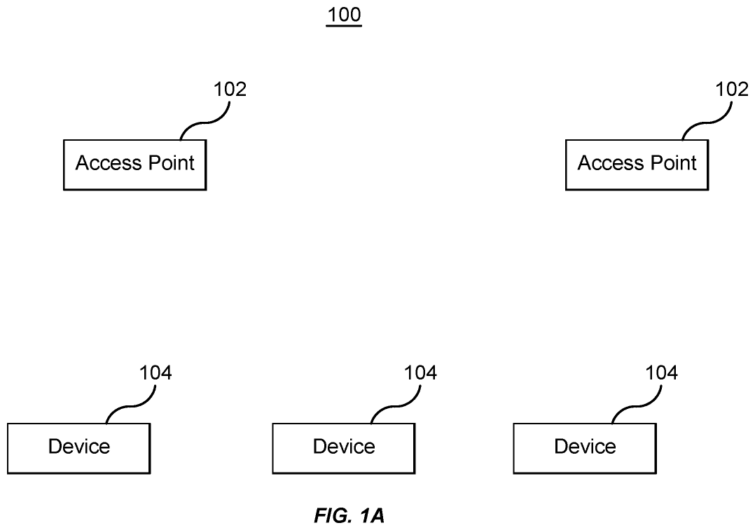

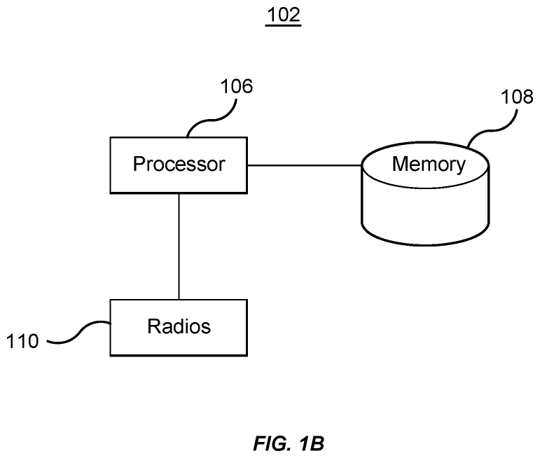

FIG. 1A illustrates an example system 100. Generally, the system 100 may be a wireless network (e.g., a wireless fidelity (WiFi) network). As seen in FIG. 1A, the system 100 includes one or more access points 102 and one or more devices 104. Generally, the devices 104 connect to the access point 102. The access points 102 provide network coverage for the system 100. The access points 102 communicate messages to the devices 104 and direct messages from the devices 104 towards their destinations.

An access point 102 facilitates wireless communication in the system 100. One or more devices 104 may connect to the access point 102. The access point 102 may then facilitate wireless communication for the connected devices 104. For example, the access point 102 may transmit messages to a connected device 104. As another example, the access point 102 may receive messages transmitted by the device 104. The access point 102 may then direct that message towards its intended destination.

A device 104 may be any suitable device that wirelessly connects to the access point 102. As an example and not by way of limitation, the device 104 may be a computer, a laptop, a wireless or cellular telephone, an electronic notebook, a personal digital assistant, a tablet, or any other device capable of receiving, processing, storing, or communicating information with other components of the system 100. The device 104 may be a wearable device such as a virtual reality or augmented reality headset, a smart watch, or smart glasses. The device 104 may also include a user interface, such as a display, a microphone, keypad, or other appropriate terminal equipment usable by the user. The device 104 may include a hardware processor, memory, or circuitry configured to perform any of the functions or actions of the device 104 described herein. For example, a software application designed using software code may be stored in the memory and executed by the processor to perform the functions of the device 104.

The device 104 may harvest electrical power from messages transmitted by the access point 102. The device 104 may then use the harvested power to perform certain functions or features of the device 104. For example, the device 104 may be an Internet-of-Things (IoT) device or a sensor. The device 104 may harvest electrical power from the messages wirelessly transmitted by the access point 102 and store that harvested power in a capacitor in the device 104. The device 104 may then use the stored power to perform certain functions. For example, the device 104 may use that power to sense an environmental condition or to report the sensed condition. As another example, the device 104 may use the stored power to actuate a switch in the device 104.

The access point 102 may allow the device 104 to negotiate the amount of power transmitted by the access point 102. For example, the device 104 may communicate a message to the access point 102 to inform the access point 102 of an amount of power previously harvested by the device 104 and an amount of power needed by the device 104. The access point 102 uses this information (along with similar information from other devices 104 in the system 100) to calculate a total power to transmit such that the device 104 (and the other devices 104) can harvest the amount of power needed. For example, the access point 102 may determine from the amount of power previously harvested by what amount the access point 102 should increase or decrease the power of a previous power transmission to provide the amount of power needed by the device 104 (and by the other devices 104). The access point 102 may then increase or decrease the power by that amount and transmit the increased or decreased power. In this manner, the access point 102 provides the devices 104 with the amount of power requested by the devices 104.

FIG. 1B illustrates an example access point 102 in the system 100 of FIG. 1A. As seen in FIG. 1B, the access point 102 includes a processor 106, a memory 108, and one or more radios 110, which may perform the functions or actions of the access point 102 described herein.

The processor 106 is any electronic circuitry, including, but not limited to one or a combination of microprocessors, microcontrollers, application specific integrated circuits (ASIC), application specific instruction set processor (ASIP), and/or state machines, that communicatively couples to the memory 108 and controls the operation of the access point 102. The processor 106 may be 8-bit, 16-bit, 32-bit, 64-bit or of any other suitable architecture. The processor 106 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 106 may include other hardware that operates software to control and process information. The processor 106 executes software stored on the memory 108 to perform any of the functions described herein. The processor 106 controls the operation and administration of the access point 102 by processing information (e.g., information received from the devices 104, memory 108, and radios 110). The processor 106 is not limited to a single processing device and may encompass multiple processing devices contained in the same device or computer or distributed across multiple devices or computers. The processor 106 is considered to perform a set of functions or actions if the multiple processing devices collectively perform the set of functions or actions, even if different processing devices perform different functions or actions in the set.

The memory 108 may store, either permanently or temporarily, data, operational software, or other information for the processor 106. The memory 108 may include any one or a combination of volatile or non-volatile local or remote devices suitable for storing information. For example, the memory 108 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 108, a disk, a CD, or a flash drive. In particular embodiments, the software may include an application executable by the processor 106 to perform one or more of the functions described herein. The memory 108 is not limited to a single memory and may encompass multiple memories contained in the same device or computer or distributed across multiple devices or computers. The memory 108 is considered to store a set of data, operational software, or information if the multiple memories collectively store the set of data, operational software, or information, even if different memories store different portions of the data, operational software, or information in the set.

The radios 110 may wirelessly communicate with devices 104 or other access points 102 in the system 100. The radios 110 may transmit and receive messages wirelessly from the devices 104 or access points 102. In some instances, the radios 110 may transmit messages from which the devices 104 harvest electrical power. The access point 102 may adjust the power in these messages according to a negotiation process performed by the devices 104 so that the messages include enough electrical power to meet the power requests from the devices 104.

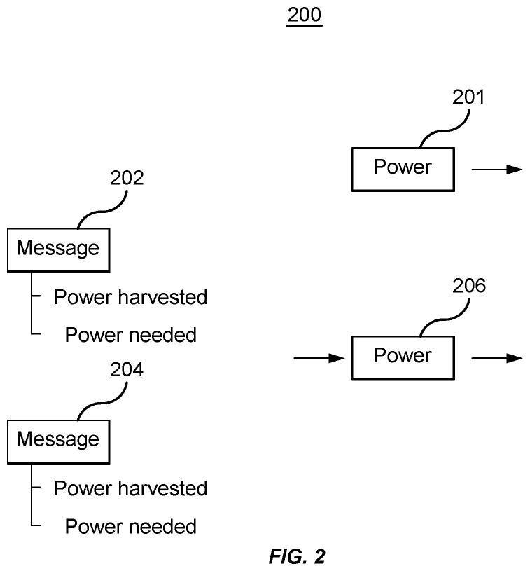

FIG. 2 illustrates an example operation 200 performed by the system 100 of FIG. 1A. Generally, the access point 102 may perform the operation 200. By performing the operation 200, the access point 102 wirelessly transmits an amount of electrical power that provides the devices 104 with amounts of power requested by the devices 104.

The access point 102 transmits an amount of electrical power 201. For example, the access point 102 may transmit wireless messages that include the amount of electrical power 201. The access point 102 may transmit these messages at certain intervals. The amount of electrical power 201 may be harvested by devices 104 in the system 100. The amount of electrical power 201 may be sufficient to allow the devices 104 to connect to or associate with the access point 102. Thus, the amount of electrical power 201 may be a baseline amount of electrical power transmitted by the access point 102. For example, the devices 104 in the system may harvest electrical power from the wireless messages that include the amount of electrical power 201. The devices 104 may then use this harvested power to transmit messages to associate with or connect to the access point 102. After the devices 104 have connected to or associated with the access point 102, the access point 102 may transmit data messages to the devices 104. The access point 102 may continue transmitting, at certain intervals, messages that include electrical power intended for harvesting after the devices 104 have connected to or associated with the access point 102. The access point 102 may allow the devices 104 to negotiate an amount of electrical power to be transmitted by the access point 102.

After the devices 104 connect to or associate with the access point 102, the devices 104 may communicate messages to the access point 102 to negotiate the amount of electrical power to be transmitted to the devices 104. In the example of FIG. 2, the access point 102 receives a message 202 and a message 204. The message 202 and the message 204 may have been transmitted by the same or different devices 104 in the system 100. Each of the messages 202 and 204 indicate an amount of electrical power previously harvested by the devices 104 and an amount of electrical power needed by the devices 104. For example, the message 202 may indicate an amount of electrical power harvested by a device 104 in a previous transmission cycle of the access point 102. Additionally, the message 202 may indicate an amount of electrical power needed by the device 104 to perform the functions or features of the device 104. The amount of power needed may be different from the amount of power previously harvested by the device 104.

The access point 102 may analyze the information in the messages 202 and 204 to determine an amount of electrical power 206 to be transmitted to provide the devices 104 with the amount of power needed by the devices 104. For example, the access point 102 may compare the power previously harvested by the devices 104 with an amount of power previously transmitted by the access point 102. The difference in the amount of power harvested and the amount of power transmitted may reflect or indicate an amount of loss or an inefficiency in the system 100. The access point 102 may then analyze the power needed by the devices 104 to determine whether additional or less power should be transmitted to provide the devices 104 with the power need indicated in the messages 202 and 204 after accounting for the losses and inefficiencies. In the example of FIG. 2, the access point 102 determines that a total amount of electrical power 206 should be transmitted to provide the devices 104 with the power needs indicated in the messages 202 and 204. The access point 102 may then generate a message that includes the total amount of electrical power 206. The access point 102 may then transmit that message so that the devices 104 may harvest electrical power from the message.

In some embodiments, the access point 102 also determines or adjusts a frequency or interval at which the messages with electrical power intended for harvesting are transmitted. For example, to provide the devices 104 with more power, the access point 102 may increase the total amount of electrical power 206 in the messages and/or increase how frequently the messages with the total amount of electrical power 206 are transmitted. To provide the devices 104 with less power, the access point may decrease the total amount of electrical power 206 in the messages and/or reduce how frequently the messages with the total amount of electrical power 206 are transmitted.

As an example, the access point 102 may transmit an amount of power (X microWatts (μW)) at an interval (e.g., every Y milliseconds (ms)). The access point 102 may receive the message 202 from a first device 104 (e.g., when the first device 104 associates with or connects to the access point 102). The messages 202 may indicate that the first device 104 previously harvested 0.5 ρW and that the first device 104 needs X ρW every Y ms. The access point 102 may use this information to determine that the access point should transmit 2X μW every Y ms to provide for the power needs of the first device 104. The access point 102 may then transmit a message that includes 2X ρW every Y ms.

The access point 102 may then receive the message 204 from a second device 104 (e.g., when the second device 104 associates with or connects to the access point 102). The messages 204 may indicate that the second device previously harvested 0.25X μW and that the second device 104 needs (i) X μW every Y ms and (ii) 2X μW every 2Y ms. The access point 102 may use this information to determine that the access point should transmit 4X μW every Y ms and 8X μW every 2Y ms to provide for the power needs of the first and second devices 104. The access point 102 may then transmit messages with the determined powers and at the determined intervals. This process may continue and accommodate any number of devices 104 with any power need at any interval.

In some embodiments, a device 104 may renegotiate the power transmitted by the access point 102. For example, the device 104 may determine that a different amount of power is needed by the device 104 (e.g., because the device 104 is performing or stopping certain features or functions). In response, the device 104 may communicate another message to the access point 102 that indicates a different amount of power needed by the device 104. The access point 102 may use the information in the message to recalculate the amount of power 206 to transmit. The access point 102 may then begin transmitting the recalculated amount of power 206 to provide for the updated power needs of the device 104.

The access point 102 may transmit messages with the calculated amount of electrical power 206 during certain portions of a transmission cycle. For example, the access point 102 may transmit these messages as power frames. As another example, the access point 102 may transmit these messages during a silent period, when the access point 102 and the devices 104 are not transmitting data messages. In this manner, transmitting and harvesting the calculated amount of electrical power 206 does not interfere with data transmissions in the system 100.

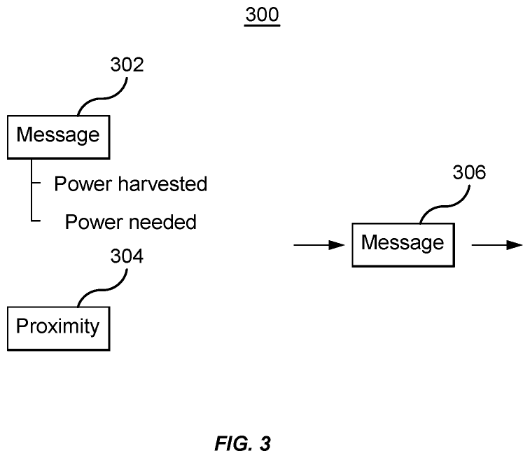

FIG. 3 illustrates an example operation 300 performed by the system 100 of FIG. 1A. Generally, the access point 102 performs the operation 300. By performing the operation 300, the access point 102 may use other access points 102 to transmit electrical power to the devices 104.

The access point 102 receives a message 302 from a connected or associated device 104. The message 302 indicates an amount of electrical power previously harvested by the device 104 (e.g., during a previous transmission cycle). The message 302 also indicates an amount of electrical power needed by the device 104. The access point 102 may determine a proximity 304 of the device 104 with the access point 102 and with other access points in the system 100. The access point 102 may use one or more ranging techniques to determine the proximity 304 of the device 104 with the access point 102 and with other access points. The access point 102 may determine from the proximity 304 that the device 104 is closer to another access point in the system 100 than to the access point 102. As a result, the access point 102 may determine that the other access point may better transmit electrical power to the device 104 than the access point 102.

The access point 102 may generate and communicate a message 306 to the other access point to instruct the other access point to transmit electrical power to the device 104. The message 306 may identify the device 104. Additionally, the message 306 may include the information in the message 302 (e.g., the amount of electrical power previously harvested by the device 104 and the amount of electrical power needed by the device 104). The access point 102 may communicate the message 306 to the other access point so that the other access point may use that information to calculate a total amount of power to transmit. The other access point may then transmit this electrical power so that the device 104 may harvest the amount of electrical power needed by the device 104. In this manner, the access point 102 may use other access points to transmit electrical power for harvesting.

In some embodiments, the access point 102 may share the power transmission responsibilities with the other access point. For example, the access point 102 may coordinate (e.g., using the message 306) power transmissions with the other access point. As a result, the access point 102 may transmit an amount of electrical power that is harvested by the device 104, and the other access point may transmit an amount of electrical power that is harvested by the device 104. In this manner, the access point 102 and the other access point cooperate to provide the power needed by the device 104.

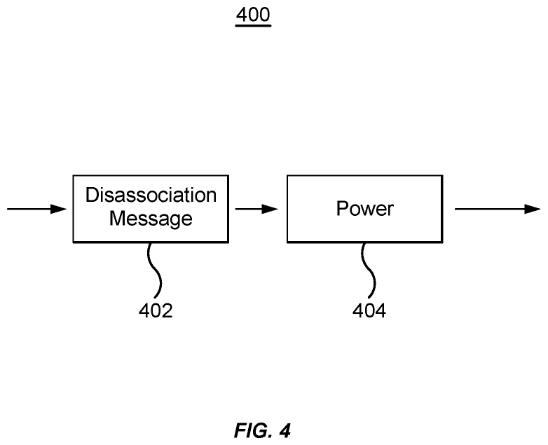

FIG. 4 illustrates an example operation 400 performed by the system 100 of FIG. 1A. Generally, the access point 102 performs the operation 400. By performing the operation 400, the access point 102 determines an amount of electrical power to transmit when a device 104 disconnects or disassociates from the access point 102.

The access point 102 receives a disassociation message 402 from a device 104. The disassociation message 402 may indicate a desire for the device 104 to disconnect or disassociate from the access point 102. For example, the device 104 may be leaving the system 100, or the device 104 may be moving or roaming to another access point 102 in the system 100. When the access point 102 receives the disassociation message 402, the access point 102 may remove the connection or association with the device 104.

Additionally, the access point 102 may recalculate an amount of electrical power 404 to transmit. For example, the device 104 may have previously indicated to the access point 102 an amount of electrical power needed by the device 104. The access point 102 may remove or disregard that amount of electrical power needed by the device 104 in response to receiving the disassociation message 402. The access point 102 may then recalculate the total amount of electrical power 404 needed by the devices 104 that are still connected to or associated with the access point 102. The access point 102 may then transmit the amount of electrical power 404 so that the connected or associated devices 104 may harvest the amount of power needed by those devices 104.

Using a previous example, a first device 104 and a second device 104 may be associated with the access point 102. The access point 102 may transmit 4X μW every Y ms and 8X μW every 2Y ms to provide for the power needs of the first and second devices 104. Specifically, the first device 104 may need X μW every Y ms, and the second device may need (i) X μW every Y ms and (ii) 2X μW every 2Y ms. The second device 104 may communicate a disassociation message 402 to the access point 102. In response, the access point 102 may disregard the power needs of the second device 104. The access point 102 may determine that the access point 102 should transmit 2X μW every Y ms to provide for the power needs of the first device 104. The access point 102 may then begin transmitting that power at that interval.

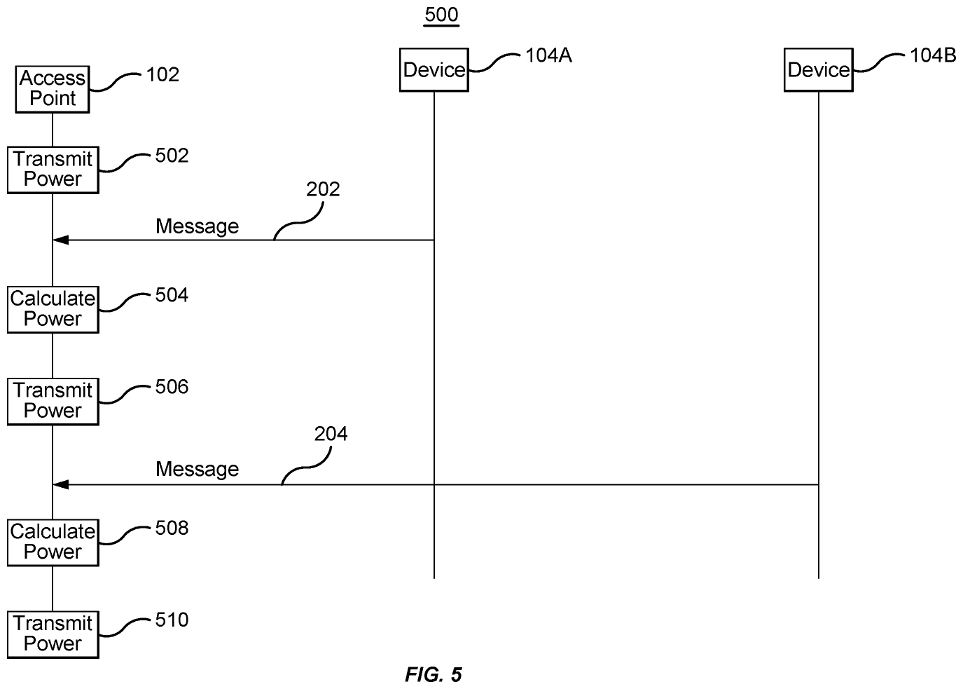

FIG. 5 is a flowchart of an example method 500 performed by the system 100 of FIG. 1A. In particular embodiments, the access point 102 performs the method 500. By performing the method 500, the access point 102 allows devices 104 to negotiate the amount of electrical power that the access point 102 transmits for harvesting.

In block 502, the access point 102 transmits an amount of electrical power for the devices 104A and 104B to harvest. The amount of electrical power may be a baseline amount of electrical power that allows the device 104A or the device 104B to connect to or associate with the access point 102. In the example of FIG. 5 the device 104A harvests the electrical power and uses that power to connect to or associated with the access point 102.

After associating with the access point 102, the device 104A transmits the message 202 to the access point 102. The message 202 may indicate an amount of electrical power previously harvested by the device 104A and an amount of electrical power needed by the device 104A. In block 504, the access point 102 may use the information in the message 202 to calculate an amount of electrical power to transmit to provide for the amount of power needed by the device 104A. The access point 102 then transmits that amount of electrical power in block 506. The device 104A may harvest the power transmitted by the access point 102 to satisfy the power needed by the device 104A.

The amount of power calculated in block 504 and transmitted in block 506 may include the baseline amount of power transmitted in block 502. The device 104B may harvest the portion of the power transmitted in block 506 to connect to or associate with the access point 102 while still allowing the device 104A to satisfy the power needs of the device 104A. After the device 104B associates with the access point 102, the device 104B transmits the message 204 to the access point 102. The message 204 may indicate an amount of electrical power previously harvested by the device 104B and an amount of power needed by the device 104B.

In block 508, the access point 102 uses the information in the message 204 to calculate a total amount of electrical power to transmit to meet the power needed by the devices 104A and 104B. In block 510, the access point 102 transmits that amount of electrical power. The devices 104A and 104B may harvest portions of that transmitted power to meet the electrical power needed by the devices 104A and 104B. The devices 104A and 104B may use that harvested power to perform the functions or features of the devices 104A or 104B. In this manner the access point 102 allows the devices 104A and 104B to negotiate the amount of electrical power transmitted by the access point 102.

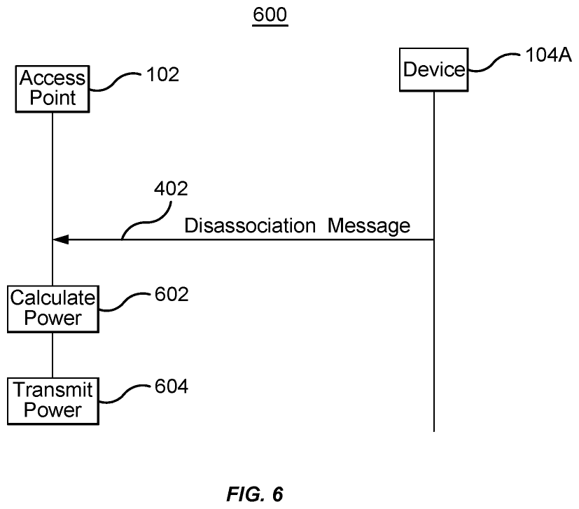

FIG. 6 is a flowchart of an example method 600 performed by the system 100 of FIG. 1A. In particular embodiments, the access point 102 performs the method 600. By performing the method 600, the access point 102 adjusts the amount of electrical power transmitted when a device disassociates from the access point 102.

As seen in FIG. 6, the access point 102 receives the disassociation message 402 from the device 104A. The disassociation message 402 may indicate that the device 104A intends to disassociate with or disconnect from the access point 102. For example, the device 104A may be leaving the system 100, or the device 104A may be roaming to another access point 102 in the system 100.

The access point 102 may recalculate the amount of electrical power to transmit in response to receiving the disassociation message 402 in block 602. For example, the access point 102 may disregard the electrical power needed by the device 104A when recalculating the power in response to receiving the disassociation message 402. The access point 102 may then transmit the calculated power in block 604. Other devices, such as the device 104B may harvest the power transmitted in block 604. The device 104A may not harvest the power transmitted in block 604. In this manner, the access point 102 may take into account disassociated or disconnected devices 104 when calculating the amount of electrical power to transmit.

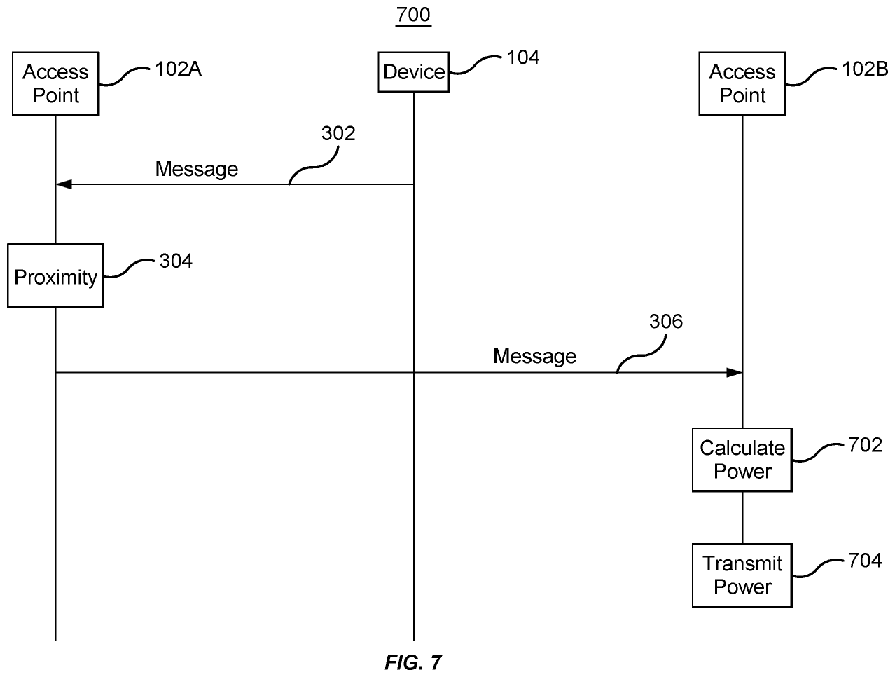

FIG. 7 is a flowchart of an example method 700 performed by the system 100 of FIG. 1A. In particular embodiments, the access point 102 performs the method 700. By performing the method 700, the access point 102 may instruct or use other access points 102 to transmit electrical power to a device 104.

As seen in FIG. 7, the access point 102A receives the message 302 from the device 104. The message 302 may indicate an amount of electrical power previously harvested by the device 104 (e.g., during a previous transmission cycle) and an amount of electrical power needed by the device 104. The access point 102A may use one or more ranging techniques to determine a proximity 304 of the device 104 to the access point 102A. The access point 102B may also use ranging techniques to determine a proximity of the device 104 to the access point 102B. Alternatively or additionally, the device 104 may use one or more ranging techniques to determine the proximity of the device 104 to the access point 102A and/or to the access point 102B. The device 104 and/or the access point 102B may communicate the determined proximities to the access point 102A. The access point 102A may consider these proximities 304 to determine whether the device 104 is closer to the access point 102A or to the access point 102B. In the example of FIG. 7, the access point 102 may determine that the device 104 is closer to the access point 102B than to the access point 102A.

In response, the access point 102A generates and communicates the message 306 to the access point 102B. The message 306 may instruct the access point 102B to transmit electrical power to the device 104. The message 306 may also include some of the information in the message 302 (e.g., the amount of electrical power previously harvested by the device 104 and/or the amount of electrical power needed by the device 104). The access point 102B may use the information in the message 306 to calculate a total amount of electrical power to transmit in block 702. The access point 102B may take into consideration the electrical power needed by other devices 104 connected to or associated with the access point 102B when calculating the power in block 702. The access point 102B may then transmit the calculated amount of electrical power in block 704. The device 104 may harvest a portion of the power transmitted in block 704 to receive the electrical power needed by the device 104. Other devices 104 that are connected to or associated with the access point 102B may also harvest a portion of the power transmitted in block 704 to satisfy their electrical power needs.

In some embodiments, the access point 102A may determine that the device 104 has a better connection to the access point 102B than to the access point 102A. For example, the access point 102A may use received signal strength indicator (RSSI) values provided by the device 104 and/or the access point 102B to determine that the device 104 has a stronger connection with the access point 102B than with the access point 102A. In response, the access point 102A may instruct the access point 102B to transmit electrical power to the device 104 using the message 306.

In summary, the access point 102 allows devices 104 to negotiate power transmissions with the access point 102. For example, if a device 104 needs the access point 102 to transmit power to the device 104 for harvesting, the device 104 may communicate a message 202 to the access point 102 to inform the access point 102 of the power previously harvested by the device 104 and the power needed by the device 104. The access point 102 may analyze these messages from multiple devices 104 to determine or calculate a total power to be transmitted that will provide the power needed by each of the devices 104. The access point 102 may then transmit this total power. The access point 102 may adjust the amount of power in subsequent transmissions based on devices 104 informing the access point 102 of the amount of power the devices 104 harvested from the transmission. In this manner, the access point 102 determines and transmits an amount of power that provides for the power needs of the devices 104. As a result, the access point 102 conserves computing resources and conserves electrical power, in certain embodiments.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. An access point comprising:
a memory; and
a processor communicatively coupled to the memory, the processor configured to:
receive, from a first device, a first message indicating a first amount of power harvested by the first device and a second amount of power requested by the first device;
determine, based on the first amount of power, that transmitting a third amount of power will cause the first device to receive the second amount of power; and
transmit the third amount of power.

2. The access point of claim 1, wherein the processor is further configured to:
receive, from a second device, a second message indicating a fourth amount of power harvested by the second device and a fifth amount of power requested by the second device, wherein the third amount of power is further based on the fourth amount of power; and
determine that transmitting the third amount of power will further cause the second device to receive the fifth amount of power.

3. The access point of claim 1, wherein the processor is further configured to:
receive, from the first device, a second message indicating a fourth amount of power requested by the first device, wherein the fourth amount of power is different from the second amount of power;
determine that transmitting a fifth amount of power will cause the first device to receive the fourth amount of power; and
transmit the fifth amount of power.

4. The access point of claim 1, wherein the processor is further configured to:
receive, from a second device, a second message indicating a fourth amount of power requested by the second device; and
in response to determining, based on a proximity of the second device to a second access point, that the second access point should provide power to the second device, communicate, to the second access point, a second message instructing the second access point to provide the fourth amount of power to the second device.

5. The access point of claim 1, wherein the processor is further configured to:
prior to receiving the first message, determine that transmitting a fourth amount of power will allow devices to associate with the access point; and
transmit the fourth amount of power.

6. The access point of claim 1, wherein transmitting the third amount of power comprises transmitting a power frame with the third amount of power.

7. The access point of claim 1, wherein the processor is further configured to schedule transmission of the third amount of power during a silent period.

8. The access point of claim 1, wherein the first message further indicates an amount of time, and wherein transmitting the third amount of power is limited based on the amount of time.

9. A method comprising:
receiving, at an access point and from a first device, a first message indicating a first amount of power harvested by the first device and a second amount of power requested by the first device;
determining, by the access point and based on the first amount of power, that transmitting a third amount of power will cause the first device to receive the second amount of power; and
transmitting, by the access point, the third amount of power.

10. The method of claim 9, further comprising:
receiving, at the access point and from a second device, a second message indicating a fourth amount of power harvested by the second device and a fifth amount of power requested by the second device, wherein the third amount of power is further based on the fourth amount of power; and
determining, by the access point, that transmitting the third amount of power will further cause the second device to receive the fifth amount of power.

11. The method of claim 9, further comprising:
receiving, at the access point and from the first device, a second message indicating a fourth amount of power requested by the first device, wherein the fourth amount of power is different from the second amount of power;
determining, by the access point, that transmitting a fifth amount of power will cause the first device to receive the fourth amount of power; and
transmitting, by the access point, the fifth amount of power.

12. The method of claim 9, further comprising:
receiving, at the access point and from a second device, a second message indicating a fourth amount of power requested by the second device; and
in response to determining, based on a proximity of the second device to a second access point, that the second access point should provide power to the second device, communicating, by the access point and to the second access point, a second message instructing the second access point to provide the fourth amount of power to the second device.

13. The method of claim 9, further comprising:
prior to receiving the first message, determining, by the access point, that transmitting a fourth amount of power will allow devices to associate with the access point; and
transmitting, by the access point, the fourth amount of power.

14. The method of claim 9, wherein transmitting the third amount of power comprises transmitting a power frame with the third amount of power.

15. The method of claim 9, further comprising scheduling transmission of the third amount of power during a silent period.

16. The method of claim 9, wherein the first message further indicates an amount of time, and wherein transmitting the third amount of power is limited based on the amount of time.

17. An apparatus comprising:
a memory; and
a processor communicatively coupled to the memory, the processor configured to:
determine, based on a first amount of power requested by a first device and a second amount of power requested by a second device, a third amount of power greater than the first amount of power and the second amount of power; and
transmit the third amount of power such that the first device receives the first amount of power and such that the second device receives the second amount of power.

18. The apparatus of claim 17, wherein the processor is further configured to:
receive, from the first device, a message indicating a fourth amount of power requested by the first device, wherein the fourth amount of power is different from the first amount of power;
determine that transmitting a fifth amount of power will cause the first device to receive the fourth amount of power; and
transmit the fifth amount of power.

19. The apparatus of claim 17, wherein the processor is further configured to:
receive, from a second device, a second message indicating a fourth amount of power requested by the second device; and
in response to determining, based on a proximity of the second device to an access point, that the access point should provide power to the second device, communicate, to the access point, a message instructing the access point to provide the fourth amount of power to the second device.

20. The apparatus of claim 17, wherein the processor is further configured to:
in response to receiving a disassociation message from the second device, determine, based on the first amount of power, a fourth amount of power less than the third amount of power; and
transmit the fourth amount of power such that the first device receives the first amount of power.
